(19) United States
(12) Patent Application Publication
(10) Pub. No.: US 2025/0267648 A1
(43) Pub. Date: Aug. 21, 2025

(54) DCI DESIGN FOR SCHEDULING OF ASSOCIATED R2D AND D2R FOR AMBIENT IOT DEVICES

(71) Applicant: APPLE INC., Cupertino, CA (US)

(72) Inventors: Ankit Bhamri, Bad Nauheim (DE); Hong He, San Jose, CA (US); Dawei Zhang, Saratoga, CA (US); Wei Zeng, San Diego, CA (US); Sigen Ye, San Diego, CA (US); Haitong Sun, Cupertino, CA (US); Zhibin Wu, Los Altos, CA (US); Naveen Kumar R. Palle Venkata, San Diego, CA (US)

(21) Appl. No.: 19/042,398

(22) Filed: Jan. 31, 2025

Related U.S. Application Data
(60) Provisional application No. 63/553,796, filed on Feb. 15, 2024.

(51) Int. Cl. H04W 72/1263; H04W 72/0446

(52) U.S. Cl. CPC H04W 72/1263; H04W 72/0446

(57) ABSTRACT

Embodiments herein include device-to-reader (D2R) and reader-to-device (R2D) scheduling of an ambient Internet of Things (IoT) device. An ambient IoT device may receive a control information message comprising scheduling information for R2D traffic and corresponding D2R traffic. Based on the scheduling information, the ambient IoT device may receive and transmit the corresponding D2R traffic in accordance with the scheduling information from the control information message.

### TECHNICAL FIELD

This application relates generally to wireless communication systems, including scheduling of device-to-reader (D2R) traffic and reader-to-device (R2D) traffic of ambient devices.

### BACKGROUND

Wireless mobile communication technology uses various standards and protocols to transmit data between a base station and a wireless communication device. Wireless communication system standards and protocols can include, for example, 3rd Generation Partnership Project (3GPP) Long Term Evolution (LTE) (e.g., 4G), 3GPP New Radio (NR) (e.g., 5G), and Institute of Electrical and Electronics Engineers (IEEE) 802.11 standard for Wireless Local Area Networks (WLAN) (commonly known to industry groups as Wi-Fi®).

As contemplated by the 3GPP, different wireless communication systems' standards and protocols can use various radio access networks (RANs) for communicating between a base station of the RAN (which may also sometimes be referred to generally as a RAN node, a network node, or simply a node) and a wireless communication device known as a user equipment (UE). 3GPP RANs can include, for example, Global System for Mobile communications (GSM), Enhanced Data Rates for GSM Evolution (EDGE) RAN (GERAN), Universal Terrestrial Radio Access Network (UTRAN), Evolved Universal Terrestrial Radio Access Network (E-UTRAN), and/or Next-Generation Radio Access Network (NG-RAN).

Each RAN may use one or more radio access technologies (RATs) to perform communication between the base station and the UE. For example, the GERAN implements GSM and/or EDGE RAT, the UTRAN implements Universal Mobile Telecommunication System (UMTS) RAT or other 3GPP RAT, the E-UTRAN implements LTE RAT (sometimes simply referred to as LTE), and NG-RAN implements NR RAT (sometimes referred to herein as 5G RAT, 5G NR RAT, or simply NR). In certain deployments, the E-UTRAN may also implement NR RAT. In certain deployments, NG-RAN may also implement LTE RAT.

A base station used by a RAN may correspond to that RAN. One example of an E-UTRAN base station is an Evolved Universal Terrestrial Radio Access Network (E-UTRAN) Node B (also commonly denoted as evolved Node B, enhanced Node B, eNodeB, or eNB). One example of an NG-RAN base station is a next generation Node B (also sometimes referred to as a g Node B or gNB).

A RAN provides its communication services with external entities through its connection to a core network (CN). For example, E-UTRAN may utilize an Evolved Packet Core (EPC) while NG-RAN may utilize a 5G Core Network (5GC).

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates three example DCIs that include a time resource field and block indication.

FIG. 2A illustrates an example embodiment where the ambient IoT device is configured with fixed monitoring occasions to receive the DCI format in accordance with some embodiments.

FIG. 2B illustrates an example embodiment where the ambient IoT device is configured with fixed monitoring occasions to receive the DCI format, where there are specific monitoring occasions for DCI for reader-to-device (R2D) only and DCI for both R2D and device-to-reader (D2R) in accordance with some embodiments.

FIG. 3 illustrates a method for an ambient IoT device, according to embodiments herein.

FIG. 4 illustrates a method for a base station, according to embodiments herein.

FIG. 5 illustrates an example architecture of a wireless communication system, according to embodiments disclosed herein.

FIG. 6 illustrates a system for performing signaling between a wireless device and a network device, according to embodiments disclosed herein.

### DETAILED DESCRIPTION

Various embodiments are described with regard to a UE. However, reference to a UE is merely provided for illustrative purposes. The example embodiments may be utilized with any electronic component that may establish a connection to a network and is configured with the hardware, software, and/or firmware to exchange information and data with the network. Therefore, the UE as described herein is used to represent any appropriate electronic component.

Additionally, embodiments herein are described with regard to Internet of Things (IoT) devices. Reference to an IoT device is merely provided for illustrative purposes, and the embodiment herein may be utilized with any device that have the capability to collect and exchange data. IoT devices may be embedded with sensors, software, and network connectivity, allowing them to communicate with other devices and systems. IoT devices can vary in size, complexity, and functionality. They can range from small, simple devices such as temperature sensors and smart home appliances to more complex devices like industrial machinery and autonomous vehicles.

Some IoT devices include ambient IoT devices. An ambient IoT device is a device that is able to harvest energy from ambient sources. For example, some ambient IoT devices may use radio frequency (RF) waves for power. To power such devices using RF, embodiments herein provide enhancements to a wireless communication system framework to introduce a new category of device(s) that is able to harvest energy from ambient sources. An ambient IoT device may be referred to as an RF powered device. An ambient IoT device may also be a UE device.

There may be multiple types of ambient IoT devices that the wireless communication system may support. For instance, in terms of energy storage, some devices may be battery-less devices with no energy storage capability at all, and completely dependent on the availability of an external source of energy. Some devices may include limited energy storage capability that do not need to be replaced or recharged manually, but can be charged by harvesting energy from ambient sources. In some embodiments, device categorization may be based on characteristics corresponding to a device (e.g., energy source, energy storage capability, passive/active transmission, etc.).

Embodiments herein consider the following set of ambient IoT devices. A first device type, (Device 1) may operate with around one microwatt (μW) peak power consumption, have energy storage, have an initial sampling frequency offset (SFO) up to 10× parts per million (ppm) (e.g., 10⁵ ppm), and provide neither reader-to-device (R2D) (e.g., downlink) nor device-to-reader (D2R) (e.g., uplink) amplification. The first device type's D2R transmission is backscattered on a carrier wave provided externally. For instance, a device may not generate its own active transmission, and reflect or backscatter an incoming signal (carrier wave).

A second device type (Device 2a) may operate with up with a peak power consumption of up to a few hundred μW, have energy storage, have an initial SFO up to 10× ppm, and provide both R2D and/or D2R amplification in the second device. The second device type's D2R transmission is backscattered on a carrier wave provided externally.

A third device type (Device 2b) may operate with up with a peak power consumption of up to a few hundred μW, have energy storage, have an initial SFO up to 10× ppm, and provide both R2D and/or D2R amplification in the third device. The third device type's D2R transmission may be generated internally by the device.

Note that R2D in ambient IoT may be downlink from the reader to the device and the channel for the R2D may be refed to as physical reader to device channel (PRDCH). D2R in ambient IoT may be uplink from the device to reader and the channel for the D2R may be refed to as physical device to reader channel (PDRCH).

For Rel-19 ambient IoT devices, two types of traffic patterns are expected to be supported for each of the categories of ambient IoT devices. A first traffic pattern to be supported is device terminated (DT). A DT traffic pattern means that R2D traffic is received and terminated at the device. For example, during a DT traffic pattern a base station or reader basically may send a command to the ambient IoT device and the device is not expected to respond back with an D2R transmission. A second type of traffic pattern to be supported includes device originated device terminated trigger (DO-DTT). A DO-DTT traffic pattern means that the R2D traffic is received at the device and the R2D traffic is used to trigger D2R traffic originating at the device. For example, an ambient IoT device may receive a R2D transmission and send an D2R response to that R2D transmission. In these two traffic patterns, there is no way that device will perform a transmission on its own (e.g., without a R2D traffic trigger in DO-DTT).

Another category of traffic includes device originated autonomous (DO-A). This means that the device can autonomously have D2R traffic without being triggered by the R2D traffic. However, in Rel-19 such a traffic pattern is not expected to be supported.

Considering the DO-DTT as the main traffic type to be supported, when D2R is also involved, a new R2D Control Information (DCI) format is considered in the following disclosure. In some embodiments, the new DCI format utilizes the association between the R2D traffic and corresponding traffic. In particular, the format to be able to support paired scheduling between R2D and D2R instead of R2D only scheduling or D2R only scheduling (like in legacy scheduling formats) is considered.

In some embodiments, a new DCI format or layer1 (L1) R2D control information can be utilized for an ambient IoT device to indicate various data and information in a dynamic manner. Embodiments herein may use the terminology DCI, however DCI is used broadly to refer to control information provided to the ambient IoT device. Accordingly, DCI or L1 R2D control information may be used interchangeably herein to refer to the control information sent from a reader or base station to an ambient IoT device.

In some embodiments the L1 R2D control information may include a scheduling type field. The scheduling type field may indicate the type of scheduling for a communication associated with the L1 R2D control information. For example, the scheduling type field can indicate whether the traffic type is only R2D or both R2D and D2R. For example, the control information may include a bit field where one value may indicate only R2D (e.g., DT traffic), and another value may indicate both R2D and D2R (e.g., DO-DTT traffic).

In another alternative embodiment, the scheduling type field may not be present in the control information. In such embodiments, other fields may be used to implicitly determine if only R2D or both R2D and D2R are scheduled by this DCI/L1 R2D control information.

In some embodiments, the DCI format/L1 R2D control information may include a time-domain resource indication for R2D blocks. In some embodiments, the time-domain resource indication can include a scheduling offset. In at least one embodiment, the scheduling offset can be defined as the duration from the end of reception of this DCI/L1 R2D control information and start of reception of a corresponding scheduled R2D channel (e.g., PDSCH). In some embodiments, the scheduling offset can indicate one value from the pre-configured values. In some embodiments, the scheduling offset can indicate an absolute duration in multiple of a time unit (e.g., in units of 10 ms or 100 ms). In some embodiments, the scheduling offset can indicate the duration in terms of number of frames and/or slots and/or symbols.

In some embodiments of the present disclosure, the time-domain resource indication for R2D blocks can include information pertaining to scheduling duration. In at least one embodiment, the scheduling duration can be defined as the duration from the start of reception of scheduled R2D channel to the end of reception. In some embodiments, similar options for scheduling offset can be applicable when determining the scheduling duration (e.g., scheduling duration may indicate one value from the preconfigured values, an absolute duration in a multiple of a time unit, and/or a duration in terms of number of frames and/or slots and/or symbols).

In some embodiments of the present disclosure, the time-domain resource indication for R2D blocks can include information pertaining to a time-synchronization error margin. In at least one embodiment, the time-synchronization error margin can be defined as a delta time duration. In some embodiments, the delta time duration can be indicated to apply at the start of scheduled R2D transmissions. In some embodiments, the delta time duration can be indicated to apply at the end of scheduled R2D transmission. In some embodiments, the delta time duration can be indicated to apply at both the start and end of the scheduled R2D transmission. In some embodiments, the time-synchronization error margin may be indicated, if configured and/or reported by UE.

Some ambient IoT devices may not be expected to have good synchronization. The delta time may provide a sort of time synchronization error margin. In some embodiments, this field is only applied in case of low-category device (e.g., device type 1). For example, a low-category device may be expected to be signaled with this field and a high-category device is not expected to be signaled with this field.

In at least one embodiment of the present disclosure, the DCI format/L1 R2D control information may include a time-domain resource indication for D2R block. The DCI format for ambient IoT device may indicate the time-domain resource indication for D2R block in a dynamic manner. In some embodiments, this field is present only if scheduling type field is set to both D2R and R2D.

In some embodiments, the time-domain resource indication for D2R block can include a scheduling offset relative to the end of reception of co-scheduled R2D. In some embodiments, the scheduling offset can indicate one value from the pre-configured values. In some embodiments, the scheduling offset can indicate an absolute duration in multiple of a time unit (e.g. in units of 10 ms or 100 ms). In some embodiments, the scheduling offset can indicate the duration in terms of number of frames and/or slots and/or symbols. In some embodiments, the other time-domain resource values (e.g., scheduling duration and time-synchronization error margin) can be the same as the R2D time-domain resource values.

In some embodiments, the time-domain resource indication for D2R block can include an indication of a scheduling offset relative to the end of reception of this DCI. In some embodiments, the scheduling offset can indicate one value from the pre-configured values. In some embodiments, the scheduling offset can indicate an absolute duration in multiple of a time unit (e.g., in units of 10 ms or 100 ms). In some embodiments, the scheduling offset can indicate the duration in terms of number of frames and/or slots and/or symbols. Other time-domain resource values (e.g., scheduling duration and time-synchronization error margin) can be the same as the R2D time-domain resource values.

In some embodiments, the time-domain resource indication for D2R block can be configured to include time domain resource values that can be separately indicated from R2D. In some embodiments, similar structure as that for R2D can be applied. In some embodiments, the scheduling offset can indicate one value from the pre-configured values. In some embodiments, the scheduling offset can indicate an absolute duration in multiple of a time unit (e.g., in units of 10 ms or 100 ms). In some embodiments, the scheduling offset can indicate the duration in terms of number of frames and/or slots and/or symbols. Other time-domain resource values (e.g., scheduling duration and time-synchronization error margin) can be indicated in the same manner as was described for the time-domain resource indication for R2D.

In some embodiments, the time-domain resource information for the D2R block may be present in the DCI/L1 R2D regardless of whether only R2D or both D2R and R2D are scheduled during the block. In such embodiments, this field value can be used to implicitly indicate whether D2R is also scheduled or not by setting some reserved or default value for all the bits in this field (that value is not applicable for time domain resource indication). Additionally, if D2R is scheduled, then the previously described options can be applied here for time domain resource indication.

In some embodiments, the DCI format/L1 R2D control information may include a field that indicates information pertaining to a number of time resource blocks. This field can be configured to indicate the number of blocks of time resources for R2D and/or D2R (e.g., the number of time resources that are indicated by other field).

In some embodiments, a single number is indicated by the number of time resource blocks field for both D2R and R2D and time gap between each block. In such embodiments, the sequence of blocks may be implicitly determined by the ambient IoT device to be alternate (e.g., R2D, D2R, R2D, D2R, R2D, D2R). Additionally, the time gap can be configured to indicate the gap between every R2D and D2R.

In some embodiments, a single number can be indicated for R2D and a factor can be indicated for D2R. In some embodiments, for every single block of R2D, corresponding blocks for D2R can be calculated. For example, if two blocks are indicated for R2D and a factor of two is indicated for D2R, then the sequence of blocks will be R2D, D2R, D2R R2D, D2R, D2R. In some embodiments, if a fractional factor is indicated, such as 0.5, then the sequence of blocks can be determined (e.g., for a fraction factor of 0.5 the sequence of blocks may be R2D, R2D, D2R. In some embodiments, a single number may be indicated for D2R and a factor may be indicated for R2D.

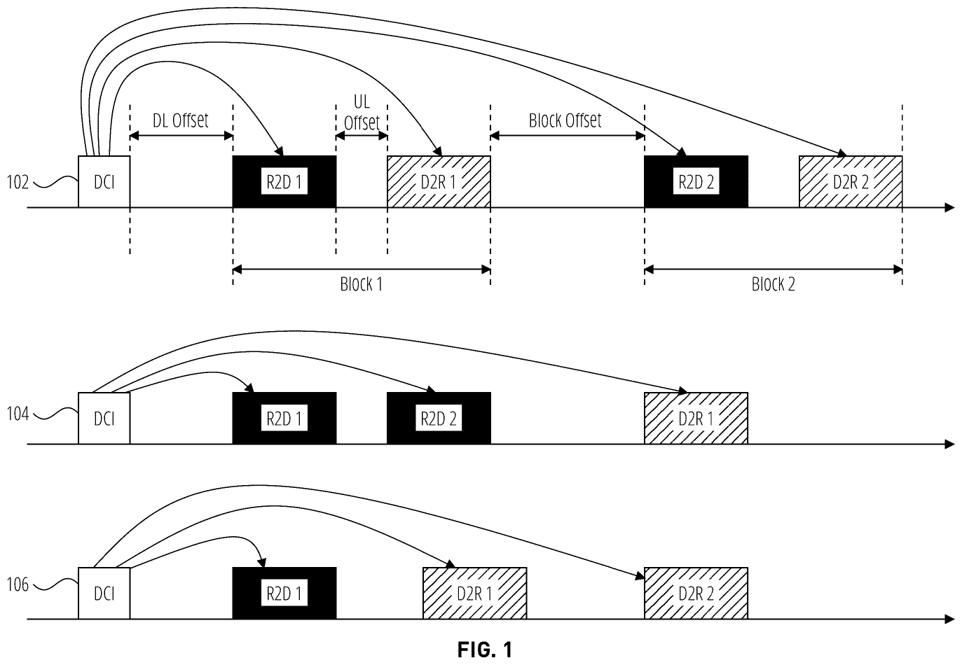

For example, FIG. 1 illustrates three example DCIs that include a time resource field and block indication. Each DCI (e.g., first DCI 102, second DCI 104, and third DCI 106) may include a scheduling type field, a time-domain resource indication for R2D block, a time-domain resource indication for D2R block, and/or a number of time resource blocks. A base station may send an ambient IoT device the DCI to indicate this information in a dynamic manner. As previously discussed these different fields may be used to indicate to the ambient IoT different timing and resource block information.

For instance, the first DCI 102 indicates that the sequence of resource blocks alternates between R2D and D2R. The second DCI 104 indicates a sequence of blocks of R2D, R2D, D2R. The third DCI 106 indicates a sequence of blocks of R2D, D2R, D2R (e.g., 2 blocks are indicated for R2D and a factor of 2 is indicated for D2R). The DCIs may further indicate a R2D offset, an D2R offset and a block offset.

In some embodiments of the present disclosure, the DCI format/L1 R2D control information may include a modulation indication. In some embodiment, this field (e.g., modulation indication field) can be supported if more than one modulation scheme can be supported for at least one of R2D (R2D (L1 R2D Control Information), PRDCH) or D2R (D2R, PDRCH). In some embodiments, the same modulation scheme can be indicated for R2D as well as D2R. This option can be supported if the same set of modulation schemes are supported for both R2D and D2R. In some embodiments, a separate modulation scheme for R2D and D2R can be indicated by the modulation indication field (e.g., OOK for R2D and BPSK for D2R). In some embodiments, the same indicated modulation scheme can be applied for all the indicated blocks.

In some embodiments, the DCI format/L1 R2D control information may include a code rate factor. This field can be supported if multiple code rates are supported for at least one of R2D or D2R. In some embodiments, the same code rate factor can be indicated for R2D and D2R. This option can be supported if the same set of modulation schemes are supported for both R2D and D2R. In some embodiments, a separate code rate factor scheme can be used for R2D and D2R. The same indicated code rate can be applied for all the indicated blocks.

In some embodiments, the DCI format/L1 R2D control information may include a mode switching field. This field can be supported for high category devices to switch between backscattering mode and active transmission mode and when D2R is scheduled.

In at least one embodiment, an ambient IoT device can be configured to monitor for a DCI format. In some embodiments, a UE-specific DCI format can be attached with a UE-specific preamble. In some embodiments, the preamble can be used for the purpose of timing synchronization. In some embodiments, the preamble can be used for identifying whether the DCI is associated with an ambient IoT device or not. This can be supported if the device in question is capable of sequence correlation. In one embodiment, this option may be supported only for high category device types.

In some embodiments, the preamble can be used to identify whether the associated DCI is scheduling only R2D, or both R2D and D2R. In one embodiment, this information can be determined based on the length of the preamble. For example, different preamble lengths may correspond to different scheduling types.

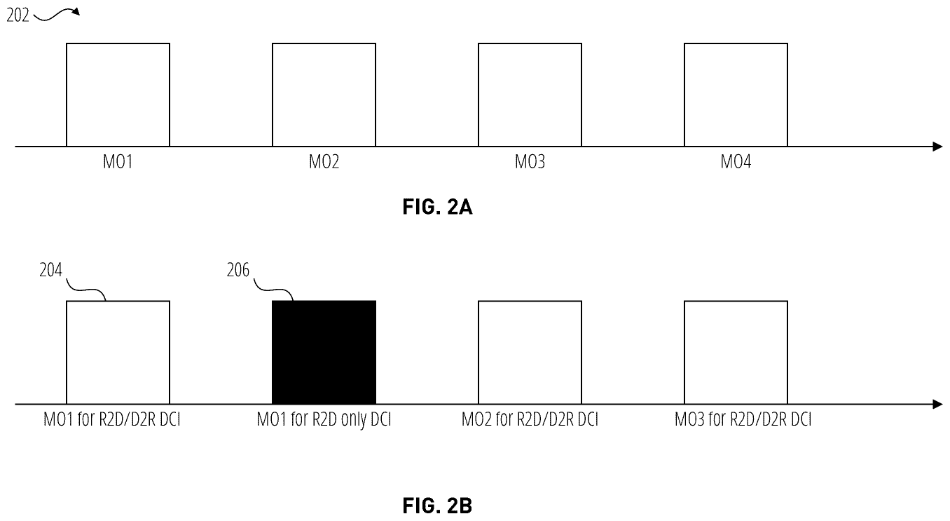

Once the ambient IoT device is connected to the network, the ambient IoT device can be configured with fixed occasions to receive the DCI format/L1 R2D control information. FIG. 2A and FIG. 2B illustrate different options for monitoring occasions for ambient IoT devices to receive DCI formats, in accordance with one or more embodiments of the present disclosure.

Specifically, FIG. 2A illustrates an example embodiment where the ambient IoT device is configured with fixed monitoring occasions to receive the DCI format, where the same monitoring occasions are used for DCI regardless of whether the DCI is a R2D scheduling DCI or both R2D and D2R scheduling DCI in accordance with some embodiments. Each occasion of the set of monitoring occasions 202 the ambient IoT device may monitor for R2D scheduling DCI or both R2D and D2R scheduling DCI.

FIG. 2B illustrates an example embodiment where the ambient IoT device is configured with fixed monitoring occasions to receive the DCI format, where there are specific monitoring occasions for DCI for R2D only and DCI for both R2D and D2R in accordance with some embodiments. For example, during first monitoring 204 the ambient IoT may monitor for a R2D and D2R DCI, and during the second monitoring occasion 206 the ambient IoT device may monitor for a R2D only DCI.

In some embodiments, an ambient IoT device can be configured to receive the DCI only once before communication is initiated.

In at least one embodiment, fixed or default configuration parameters can be applied for physical R2D channels carrying DCI formats. For example, default configuration parameters for time resources, DCI length/overhead, modulation scheme, and coding rates can be applied for physical R2D channels carrying DCI. In some embodiments, DCI length can be fixed regardless of exact fields included or not. In some embodiments, only single DCI lengths can be supported.

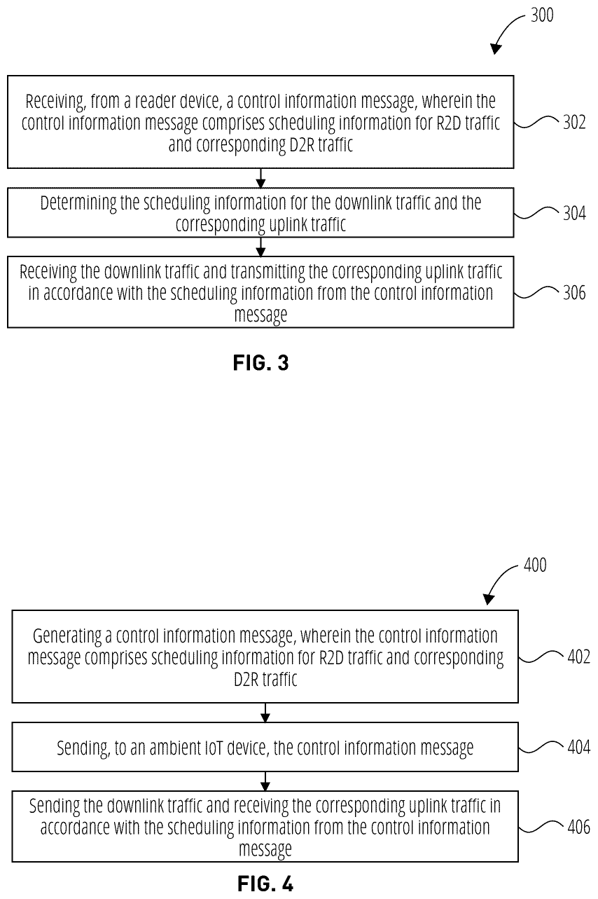

FIG. 3 illustrates a method 300 for an ambient IoT device, according to embodiments herein. The illustrated method 300 includes receiving 302, from a reader device, a control information message, wherein the control information message comprises scheduling information for R2D traffic and corresponding D2R traffic for a DO-DTT traffic pattern. The method 300 further includes determining 304 the scheduling information for the R2D traffic and the corresponding D2R traffic. The method 300 further includes receiving 306 the R2D traffic and transmitting the corresponding D2R traffic in accordance with the scheduling information from the control information message.

In some embodiments of the method 300, the scheduling information comprises a time-domain resource indication for a R2D block for the R2D traffic, the time-domain resource indication for the R2D block comprising a scheduling offset for the R2D block, a scheduling duration for the R2D block, a time-synchronization error margin, or a combination thereof.

In some embodiments of the method 300, the scheduling information comprises a time-domain resource indication for an D2R block for the corresponding D2R traffic, the time-domain resource indication for the D2R block comprising a scheduling offset for the D2R block. In some such embodiments, the scheduling offset for the D2R block is relative to an end of reception of the R2D traffic that is co-scheduled in the control information message. In some other such embodiments, the scheduling offset for the D2R block is relative to an end of reception of the control information message.

In some embodiments of the method 300, the scheduling information comprises separate time domain resource values for the R2D traffic and the corresponding D2R traffic.

In some embodiments of the method 300, the scheduling information indicates a number of R2D blocks of time resources for the R2D traffic and a factor that the ambient IoT device applies to the number of R2D blocks to determine a number of D2R blocks for the corresponding D2R traffic.

In some embodiments of the method 300, the scheduling information includes a modulation indication for the R2D traffic and the corresponding D2R traffic, a code rate factor for the R2D traffic and the corresponding D2R traffic, a preamble for timing synchronization, or a combination thereof.

In some embodiments, the method 300 further comprises receiving a configuration for monitoring fixed occasions to receive the control information message.

In some embodiments of the method 300, default configuration parameters are applied for a physical R2D channel carrying the control information message.

FIG. 4 illustrates a method 400 for a base station, according to embodiments herein. The illustrated method 400 includes generating 402 a control information message, wherein the control information message comprises scheduling information for R2D traffic and corresponding D2R traffic for a DO-DTT traffic pattern. The method 400 further includes sending 404, to an ambient IoT device, the control information message. The method 400 further includes sending 406 the R2D traffic and receiving the corresponding D2R traffic in accordance with the scheduling information from the control information message.

In some embodiments of the method 400, the scheduling information comprises a time-domain resource indication for a R2D block for the R2D traffic, the time-domain resource indication for the R2D block comprising a scheduling offset for the R2D block, a scheduling duration for the R2D block, a time-synchronization error margin, or a combination thereof.

In some embodiments of the method 400, the scheduling information comprises a time-domain resource indication for an D2R block for the corresponding D2R traffic, the time-domain resource indication for the D2R block comprising a scheduling offset for the D2R block. In some such embodiments, the scheduling offset for the D2R block is relative to an end of reception of the R2D traffic that is co-scheduled in the control information message. In some other such embodiments, the scheduling offset for the D2R block is relative to an end of reception of the control information message.

In some embodiments of the method 400, the scheduling information comprises separate time domain resource values for the R2D traffic and the corresponding D2R traffic.

In some embodiments of the method 400, the scheduling information indicates a number of R2D blocks of time resources for the R2D traffic and a factor that the ambient IoT device applies to the number of R2D blocks to determine a number of D2R blocks for the corresponding D2R traffic.

In some embodiments of the method 400, the scheduling information includes a modulation indication for the R2D traffic and the corresponding D2R traffic, a code rate factor for the R2D traffic and the corresponding D2R traffic, a preamble for timing synchronization, or a combination thereof.

In some embodiments, the method 400 further comprises sending a configuration for monitoring fixed occasions to receive the control information message.

In some embodiments of the method 400, default configuration parameters are applied for a physical R2D channel carrying the control information message.

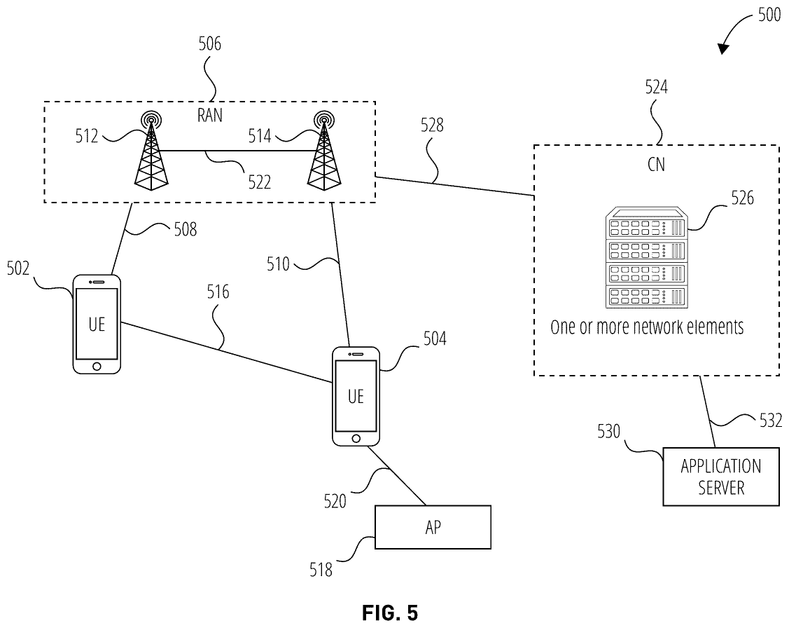

FIG. 5 illustrates an example architecture of a wireless communication system 500, according to embodiments disclosed herein. The following description is provided for an example wireless communication system 500 that operates in conjunction with the LTE system standards and/or 5G or NR system standards as provided by 3GPP technical specifications.

As shown by FIG. 5, the wireless communication system 500 includes UE 502 and UE 504 (although any number of UEs may be used). In this example, the UE 502 and the UE 504 are illustrated as smartphones (e.g., handheld touchscreen mobile computing devices connectable to one or more cellular networks), but may also comprise any mobile or non-mobile computing device configured for wireless communication.

The UE 502 and UE 504 may be configured to communicatively couple with a RAN 506. In embodiments, the RAN 506 may be NG-RAN, E-UTRAN, etc. The UE 502 and UE 504 utilize connections (or channels) (shown as connection 508 and connection 510, respectively) with the RAN 506, each of which comprises a physical communications interface. The RAN 506 can include one or more base stations (such as base station 512 and base station 514) that enable the connection 508 and connection 510.

In this example, the connection 508 and connection 510 are air interfaces to enable such communicative coupling, and may be consistent with RAT(s) used by the RAN 506, such as, for example, an LTE and/or NR.

In some embodiments, the UE 502 and UE 504 may also directly exchange communication data via a sidelink interface 516. The UE 504 is shown to be configured to access an access point (shown as AP 518) via connection 520. By way of example, the connection 520 can comprise a local wireless connection, such as a connection consistent with any IEEE 802.11 protocol, wherein the AP 518 may comprise a Wi-Fi® router. In this example, the AP 518 may be connected to another network (for example, the Internet) without going through a CN 524.

In embodiments, the UE 502 and UE 504 can be configured to communicate using orthogonal frequency division multiplexing (OFDM) communication signals with each other or with the base station 512 and/or the base station 514 over a multicarrier communication channel in accordance with various communication techniques, such as, but not limited to, an orthogonal frequency division multiple access (OFDMA) communication technique (e.g., for R2D communications) or a single carrier frequency division multiple access (SC-FDMA) communication technique (e.g., for D2R and ProSc or sidelink communications), although the scope of the embodiments is not limited in this respect. The OFDM signals can comprise a plurality of orthogonal subcarriers.

In some embodiments, all or parts of the base station 512 or base station 514 may be implemented as one or more software entities running on server computers as part of a virtual network. In addition, or in other embodiments, the base station 512 or base station 514 may be configured to communicate with one another via interface 522. In embodiments where the wireless communication system 500 is an LTE system (e.g., when the CN 524 is an EPC), the interface 522 may be an X2 interface. The X2 interface may be defined between two or more base stations (e.g., two or more eNBs and the like) that connect to an EPC, and/or between two eNBs connecting to the EPC. In embodiments where the wireless communication system 500 is an NR system (e.g., when CN 524 is a 5GC), the interface 522 may be an Xn interface. The Xn interface is defined between two or more base stations (e.g., two or more gNBs and the like) that connect to 5GC, between a base station 512 (e.g., a gNB) connecting to 5GC and an eNB, and/or between two eNBs connecting to 5GC (e.g., CN 524).

The RAN 506 is shown to be communicatively coupled to the CN 524. The CN 524 may comprise one or more network elements 526, which are configured to offer various data and telecommunications services to customers/subscribers (e.g., users of UE 502 and UE 504) who are connected to the CN 524 via the RAN 506. The components of the CN 524 may be implemented in one physical device or separate physical devices including components to read and execute instructions from a machine-readable or computer-readable medium (e.g., a non-transitory machine-readable storage medium).

In embodiments, the CN 524 may be an EPC, and the RAN 506 may be connected with the CN 524 via an S1 interface 528. In embodiments, the S1 interface 528 may be split into two parts, an S1 user plane (S1-U) interface, which carries traffic data between the base station 512 or base station 514 and a serving gateway (S-GW), and the S1-MME interface, which is a signaling interface between the base station 512 or base station 514 and mobility management entities (MMEs).

In embodiments, the CN 524 may be a 5GC, and the RAN 506 may be connected with the CN 524 via an NG interface 528. In embodiments, the NG interface 528 may be split into two parts, an NG user plane (NG-U) interface, which carries traffic data between the base station 512 or base station 514 and a user plane function (UPF), and the S1 control plane (NG-C) interface, which is a signaling interface between the base station 512 or base station 514 and access and mobility management functions (AMFs).

Generally, an application server 530 may be an element offering applications that use internet protocol (IP) bearer resources with the CN 524 (e.g., packet switched data services). The application server 530 can also be configured to support one or more communication services (e.g., VOIP sessions, group communication sessions, etc.) for the UE 502 and UE 504 via the CN 524. The application server 530 may communicate with the CN 524 through an IP communications interface 532.

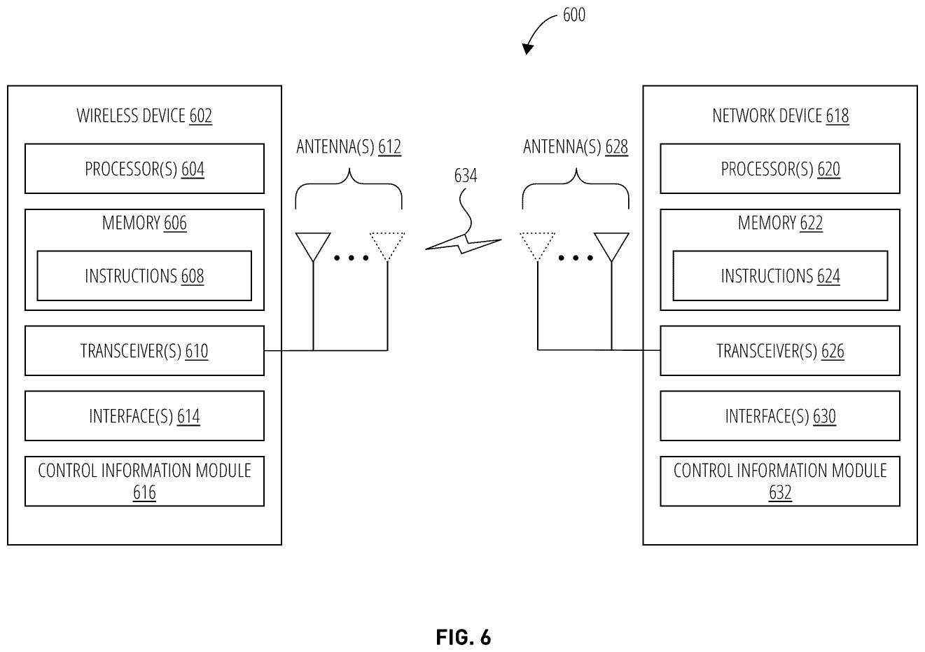

FIG. 6 illustrates a system 600 for performing signaling 634 between a wireless device 602 and a network device 618, according to embodiments disclosed herein. The system 600 may be a portion of a wireless communications system as herein described. The wireless device 602 may be, for example, a UE of a wireless communication system. The network device 618 may be, for example, a base station (e.g., an eNB or a gNB) of a wireless communication system.

The wireless device 602 may include one or more processor(s) 604. The processor(s) 604 may execute instructions such that various operations of the wireless device 602 are performed, as described herein. The processor(s) 604 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The wireless device 602 may include a memory 606. The memory 606 may be a non-transitory computer-readable storage medium that stores instructions 608 (which may include, for example, the instructions being executed by the processor(s) 604). The instructions 608 may also be referred to as program code or a computer program. The memory 606 may also store data used by, and results computed by, the processor(s) 604.

The wireless device 602 may include one or more transceiver(s) 610 that may include radio frequency (RF) transmitter circuitry and/or receiver circuitry that use the antenna(s) 612 of the wireless device 602 to facilitate signaling (e.g., the signaling 634) to and/or from the wireless device 602 with other devices (e.g., the network device 618) according to corresponding RATs.

The wireless device 602 may include one or more antenna(s) 612 (e.g., one, two, four, or more). For embodiments with multiple antenna(s) 612, the wireless device 602 may leverage the spatial diversity of such multiple antenna(s) 612 to send and/or receive multiple different data streams on the same time and frequency resources. This behavior may be referred to as, for example, multiple input multiple output (MIMO) behavior (referring to the multiple antennas used at each of a transmitting device and a receiving device that enable this aspect). MIMO transmissions by the wireless device 602 may be accomplished according to precoding (or digital beamforming) that is applied at the wireless device 602 that multiplexes the data streams across the antenna(s) 612 according to known or assumed channel characteristics such that each data stream is received with an appropriate signal strength relative to other streams and at a desired location in the spatial domain (e.g., the location of a receiver associated with that data stream). Certain embodiments may use single user MIMO (SU-MIMO) methods (where the data streams are all directed to a single receiver) and/or multi user MIMO (MU-MIMO) methods (where individual data streams may be directed to individual (different) receivers in different locations in the spatial domain).

In certain embodiments having multiple antennas, the wireless device 602 may implement analog beamforming techniques, whereby phases of the signals sent by the antenna(s) 612 are relatively adjusted such that the (joint) transmission of the antenna(s) 612 can be directed (this is sometimes referred to as beam steering).

The wireless device 602 may include one or more interface(s) 614. The interface(s) 614 may be used to provide input to or output from the wireless device 602. For example, a wireless device 602 that is a UE may include interface(s) 614 such as microphones, speakers, a touchscreen, buttons, and the like in order to allow for input and/or output to the UE by a user of the UE. Other interfaces of such a UE may be made up of transmitters, receivers, and other circuitry (e.g., other than the transceiver(s) 610/antenna(s) 612 already described) that allow for communication between the UE and other devices and may operate according to known protocols (e.g., Wi-Fi®, Bluetooth®, and the like).

The wireless device 602 may include a control information module 616. The control information module 616 may be implemented via hardware, software, or combinations thereof. For example, the control information module 616 may be implemented as a processor, circuit, and/or instructions 608 stored in the memory 606 and executed by the processor(s) 604. In some examples, the control information module 616 may be integrated within the processor(s) 604 and/or the transceiver(s) 610. For example, the control information module 616 may be implemented by a combination of software components (e.g., executed by a DSP or a general processor) and hardware components (e.g., logic gates and circuitry) within the processor(s) 604 or the transceiver(s) 610.

The control information module 616 may be used for various aspects of the present disclosure, for example, aspects of FIGS. 1-5.

The network device 618 may include one or more processor(s) 620. The processor(s) 620 may execute instructions such that various operations of the network device 618 are performed, as described herein. The processor(s) 620 may include one or more baseband processors implemented using, for example, a CPU, a DSP, an ASIC, a controller, an FPGA device, another hardware device, a firmware device, or any combination thereof configured to perform the operations described herein.

The network device 618 may include a memory 622. The memory 622 may be a non-transitory computer-readable storage medium that stores instructions 624 (which may include, for example, the instructions being executed by the processor(s) 620). The instructions 624 may also be referred to as program code or a computer program. The memory 622 may also store data used by, and results computed by, the processor(s) 620.

The network device 618 may include one or more transceiver(s) 626 that may include RF transmitter circuitry and/or receiver circuitry that use the antenna(s) 628 of the network device 618 to facilitate signaling (e.g., the signaling 634) to and/or from the network device 618 with other devices (e.g., the wireless device 602) according to corresponding RATs.

The network device 618 may include one or more antenna(s) 628 (e.g., one, two, four, or more). In embodiments having multiple antenna(s) 628, the network device 618 may perform MIMO, digital beamforming, analog beamforming, beam steering, etc., as has been described.

The network device 618 may include one or more interface(s) 630. The interface(s) 630 may be used to provide input to or output from the network device 618. For example, a network device 618 that is a base station may include interface(s) 630 made up of transmitters, receivers, and other circuitry (e.g., other than the transceiver(s) 626/antenna(s) 628 already described) that enables the base station to communicate with other equipment in a core network, and/or that enables the base station to communicate with external networks, computers, databases, and the like for purposes of operations, administration, and maintenance of the base station or other equipment operably connected thereto.

The network device 618 may include a control information module 632. The control information module 632 may be implemented via hardware, software, or combinations thereof. For example, the control information module 632 may be implemented as a processor, circuit, and/or instructions 624 stored in the memory 622 and executed by the processor(s) 620. In some examples, the control information module 632 may be integrated within the processor(s) 620 and/or the transceiver(s) 626. For example, the control information module 632 may be implemented by a combination of software components (e.g., executed by a DSP or a general processor) and hardware components (e.g., logic gates and circuitry) within the processor(s) 620 or the transceiver(s) 626.

The control information module 632 may be used for various aspects of the present disclosure, for example, aspects of FIGS. 1-5.

Embodiments contemplated herein include an apparatus comprising means to perform one or more elements of the method 300. This apparatus may be, for example, an apparatus of a UE (such as a wireless device 602 that is a UE, as described herein).

Embodiments contemplated herein include one or more non-transitory computer-readable media comprising instructions to cause an electronic device, upon execution of the instructions by one or more processors of the electronic device, to perform one or more elements of the method 300. This non-transitory computer-readable media may be, for example, a memory of a UE (such as a memory 606 of a wireless device 602 that is a UE, as described herein).

Embodiments contemplated herein include an apparatus comprising logic, modules, or circuitry to perform one or more elements of the method 300. This apparatus may be, for example, an apparatus of a UE (such as a wireless device 602 that is a UE, as described herein).

Embodiments contemplated herein include an apparatus comprising: one or more processors and one or more computer-readable media comprising instructions that, when executed by the one or more processors, cause the one or more processors to perform one or more elements of the method 300. This apparatus may be, for example, an apparatus of a UE (such as a wireless device 602 that is a UE, as described herein).

Embodiments contemplated herein include a signal as described in or related to one or more elements of the method 300.

Embodiments contemplated herein include a computer program or computer program product comprising instructions, wherein execution of the program by a processor is to cause the processor to carry out one or more elements of the method 300. The processor may be a processor of a UE (such as a processor(s) 604 of a wireless device 602 that is a UE, as described herein). These instructions may be, for example, located in the processor and/or on a memory of the UE (such as a memory 606 of a wireless device 602 that is a UE, as described herein).

Embodiments contemplated herein include an apparatus comprising means to perform one or more elements of the method 400. This apparatus may be, for example, an apparatus of a base station (such as a network device 618 that is a base station, as described herein).

Embodiments contemplated herein include one or more non-transitory computer-readable media comprising instructions to cause an electronic device, upon execution of the instructions by one or more processors of the electronic device, to perform one or more elements of the method 400. This non-transitory computer-readable media may be, for example, a memory of a base station (such as a memory 622 of a network device 618 that is a base station, as described herein).

Embodiments contemplated herein include an apparatus comprising logic, modules, or circuitry to perform one or more elements of the method 400. This apparatus may be, for example, an apparatus of a base station (such as a network device 618 that is a base station, as described herein).

Embodiments contemplated herein include an apparatus comprising: one or more processors and one or more computer-readable media comprising instructions that, when executed by the one or more processors, cause the one or more processors to perform one or more elements of the method 400. This apparatus may be, for example, an apparatus of a base station (such as a network device 618 that is a base station, as described herein).

Embodiments contemplated herein include a signal as described in or related to one or more elements of the method 400.

Embodiments contemplated herein include a computer program or computer program product comprising instructions, wherein execution of the program by a processing element is to cause the processing element to carry out one or more elements of the method 400. The processor may be a processor of a base station (such as a processor(s) 620 of a network device 618 that is a base station, as described herein). These instructions may be, for example, located in the processor and/or on a memory of the base station (such as a memory 622 of a network device 618 that is a base station, as described herein).

For one or more embodiments, at least one of the components set forth in one or more of the preceding figures may be configured to perform one or more operations, techniques, processes, and/or methods as set forth herein. For example, a baseband processor as described herein in connection with one or more of the preceding figures may be configured to operate in accordance with one or more of the examples set forth herein. For another example, circuitry associated with a UE, base station, network element, etc. as described above in connection with one or more of the preceding figures may be configured to operate in accordance with one or more of the examples set forth herein.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

It should be recognized that the systems described herein include descriptions of specific embodiments. These embodiments can be combined into single systems, partially combined into other systems, split into multiple systems or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

1. A method for an ambient Internet of Things (IoT) device, the method comprising:
receiving, from a reader device, a control information message, wherein the control information message comprises scheduling information for reader-to-device (R2D) traffic and corresponding device-to-reader (D2R) traffic;
determining the scheduling information for the R2D traffic and the corresponding D2R traffic; and
receiving the R2D traffic and transmitting the corresponding D2R traffic in accordance with the scheduling information from the control information message.

2. The method of claim 1, wherein the scheduling information comprises a time-domain resource indication for a R2D block for the R2D traffic, the time-domain resource indication for the R2D block comprising a scheduling offset for the R2D block, a scheduling duration for the R2D block, a time-synchronization error margin, or a combination thereof.

3. The method of claim 1, wherein the scheduling information comprises a time-domain resource indication for an D2R block for the corresponding D2R traffic, the time-domain resource indication for the D2R block comprising a scheduling offset for the D2R block.

4. The method of claim 3, wherein the scheduling offset for the D2R block is relative to an end of reception of the R2D traffic that is co-scheduled in the control information message.

5. The method of claim 3, wherein the scheduling offset for the D2R block is relative to an end of reception of the control information message.

6. The method of claim 1, wherein the scheduling information comprises separate time domain resource values for the R2D traffic and the corresponding D2R traffic.

7. The method of claim 1, wherein the scheduling information indicates a number of R2D blocks of time resources for the R2D traffic and a factor that the ambient IoT device applies to the number of R2D blocks to determine a number of D2R blocks for the corresponding D2R traffic.

8. The method of claim 1, wherein the scheduling information includes a modulation indication for the R2D traffic and the corresponding D2R traffic, a code rate factor for the R2D traffic and the corresponding D2R traffic, a preamble for timing synchronization, or a combination thereof.

9. The method of claim 1, further comprising receiving a configuration for monitoring fixed occasions to receive the R2D control information message.

10. The method of claim 1, wherein default configuration parameters are applied for a physical R2D channel (PRDCH) carrying the R2D control information message.

11. A method for a base station, the method comprising:
generating a control information message, wherein the control information message comprises scheduling information for reader-to-device (R2D) traffic and corresponding device-to-reader (D2R) traffic;
sending, to an ambient Internet of Things (IoT) device, the control information message; and
sending the R2D traffic and receiving the corresponding D2R traffic in accordance with the scheduling information from the control information message.

12. The method of claim 11, wherein the scheduling information comprises a time-domain resource indication for a R2D block for the R2D traffic, the time-domain resource indication for the R2D block comprising a scheduling offset for the R2D block, a scheduling duration for the R2D block, a time-synchronization error margin, or a combination thereof.

13. The method of claim 11, wherein the scheduling information comprises a time-domain resource indication for an D2R block for the corresponding D2R traffic, the time-domain resource indication for the D2R block comprising a scheduling offset for the D2R block.

14. The method of claim 13, wherein the scheduling offset for the D2R block is relative to an end of reception of the R2D traffic that is co-scheduled in the control information message.

15. The method of claim 13, wherein the scheduling offset for the D2R block is relative to an end of reception of the control information message.

16. The method of claim 11, wherein the scheduling information comprises separate time domain resource values for the R2D traffic and the corresponding D2R traffic.

17. The method of claim 11, wherein the scheduling information indicates a number of R2D blocks of time resources for the R2D traffic and a factor that the ambient IoT device applies to the number of R2D blocks to determine a number of D2R blocks for the corresponding D2R traffic.

18. The method of claim 11, wherein the scheduling information includes a modulation indication for the R2D traffic and the corresponding D2R traffic, a code rate factor for the R2D traffic and the corresponding D2R traffic, a preamble for timing synchronization, or a combination thereof.

19. The method of claim 11, further comprising sending a configuration for monitoring fixed occasions to receive the control information message.

20. An ambient Internet of Things (IoT) device apparatus comprising:
a processor; and
a memory storing instructions that, when executed by the processor, configure the apparatus to:
receive, from a reader device, a control information message, wherein the control information message comprises scheduling information for reader-to-device (R2D) traffic and corresponding device-to reader (D2R);
determine the scheduling information for the R2D traffic and the corresponding D2R traffic; and
receive the R2D traffic and transmitting the corresponding D2R traffic in accordance with the scheduling information from the control information message.
